(19) United States
(12) Patent Application Publication
(10) Pub. No.: US 2022/0155796 A1
(43) Pub. Date: May 19, 2022

(54) Collaborative Mobility Risk Assessment Platform

(71) Applicant: Vinli, Inc., Dallas, TX (US)

(72) Inventors: Mahmoud Haidar, Dallas, TX (US); Matthew Himelfarb, Dallas, TX (US); Vann Walke, Dallas, TX (US); Brian Brennan, Dallas, TX (US); Ray Hernandez, Dallas, TX (US); Curtis Thornton, Dallas, TX (US); Keegan Ruebling, Dallas, TX (US)

(21) Appl. No.: 17/529,905

(22) Filed: Nov. 18, 2021

Related U.S. Application Data
(60) Provisional application No. 63/115,581, filed on Nov. 18, 2020.

(51) Int. Cl. G05D 1/02; G06Q 40/08; B60W 50/14; B60K 35/00; B60W 60/00; H04L 29/08

(52) U.S. Cl. CPC G05D 1/0285; G06Q 40/08; G05D 1/0291; B60W 50/14; B60K 35/00; B60K 2370/167; H04L 67/10; B60W 2540/215; B60W 2556/55; B60K 2370/12; B60K 2370/166; B60W 60/0015

(57) ABSTRACT

A collaborative mobility risk assessment platform may enable multiple parties to participate in the assessment and mitigation of risk facing all forms of autonomous and non-autonomous vehicles via machine learning and artificial intelligence. The platform may include interfaces to ingest a plurality of forms of telematics data, driver history data, weather data, insurance data, vehicle history data, traffic data, road condition data as well as any relevant third-party data that may be used to predict the risk of collision, breakdown, or accelerated depreciation of autonomous and non-autonomous vehicles. The platform may be shared with multiple parties for purposes of collaboration for risk mitigation so as to minimize or eliminate sub-standard performance and/or non-performance with respect to areas including, but not limited to, routes, insurance policies, maintenance, fuel management, and/or asset pricing using cloud-based services.

### CROSS-REFERENCE TO RELATED APPLICATION

The present application is a non-provisional of, and claims priority to, U.S. Patent Application No. 63/115,581 filed Nov. 18, 2020, which is incorporated by reference in its entirety.

### FIELD OF THE DISCLOSURE

The present disclosure generally relates to risk assessment, and more particularly to collaborative mobility risk assessment.

### BACKGROUND

Different types of data including telematics data, driver history data, weather data, insurance data, vehicle history data, traffic data, and/or road condition data may be collected with regard to autonomous and non-autonomous vehicles. However, these different types of data are often collected in different places or using different systems. This can make it time-consuming and costly for data scientists to coalesce and analyze the data in order to advise actuarial scientists, insurance companies, and/or companies working with telematics, among others, on risks of collision, breakdown, or accelerated depreciation of autonomous and non-autonomous vehicles.

### SUMMARY

Embodiments of the present disclosure may provide a collaborative mobility risk assessment platform that may enable multiple parties to participate in the assessment and mitigation of risk with respect to autonomous and non-autonomous vehicles via machine learning and artificial intelligence. The platform according to embodiments of the present disclosure may include one or more interfaces to ingest a plurality of forms of data including, but not limited to, telematics data, driver history data, weather data, insurance data, vehicle history data, traffic data, road condition data as well as any relevant third-party data that may be used to predict the risk of collision, breakdown, or accelerated depreciation of autonomous and non-autonomous vehicles. The platform according to embodiments of the present disclosure may be shared with multiple parties for purposes of collaboration to provide various forms of risk mitigation so as to minimize or eliminate sub-standard performance and/or non-performance with respect to areas or optimization including, but not limited to, routes, insurance policies, maintenance, fuel management, and/or asset pricing using cloud-based services.

Embodiments of the present disclosure may provide a method for collaborative mobility risk assessment comprising: receiving a datahub having one or more data lakes into a cloud-based collaborative mobility risk assessment platform, the collaborative mobility risk assessment platform including a road safety index, a driver risk index, and predictive maintenance; feeding the road safety index, the driver risk index, and predictive maintenance to one or more client applications; and using push-button deployment via a graphical user interface (GUI) of the collaborative mobility risk assessment platform, providing an interactive system for driving optimization, wherein the collaborative mobility risk assessment platform may be sharable with multiple parties to participate in assessment and mitigation of risk for a plurality of types of autonomous and non-autonomous vehicles. The interactive system for driving optimization may comprise a fully interactive dashboard for live business analytics, prebuilt metric or visual views, and custom views. The one or more data lakes may be manual and/or automatic. The manual data lake may be populated through a fully interactive dashboard for live business analytics in the interactive system for driving optimization. The automatic data lakes may be populated from one or more external sources. The one or more external sources may be a telematics service provider that may provide telematics data through a standard application programming interface (API) and/or a supplier API. The one or more data lakes may be an automatic data lake that receives data through one or more data processing APIs. The data may be selected from the group comprising: weather data, map data, financial data, maintenance data, and emission data. The one or more data lakes may be an automatic data lake that receives data through one or more APIs selected from the group comprising: device, transaction, vehicle, event, telemetry, trip, diagnostic, safety, and/or behavioral APIs. The multiple parties may include a provider of the collaborative mobility risk assessment platform, insurance companies, fleet managers, automobile manufacturers (OEM), sellers of after-market automotive parts or services, vehicle dealerships, providers of alternative mobility solutions, and banking institutions. The plurality of types of autonomous and non-autonomous vehicles may include cars, light and heavy trucks, motorcycles, scooters, bicycles, and alternative mobility solutions. The one or more client applications may be selected from the group comprising: route optimization, input for upgraded driver risk index, insurance policy pricing, driver safety/monitoring, and asset management and residual value.

Other embodiments of the present disclosure may provide a collaborative mobility risk assessment platform comprising: one or more interfaces to ingest a plurality of forms of data and populate one or more data lakes that feed into a datahub; a cloud-based collaborative mobility risk assessment platform that receives the datahub, the collaborative mobility risk assessment platform including a road safety index, a driver risk index, and predictive maintenance; one or more client applications that receive the road safety index, the driver risk index, and/or predictive maintenance from the collaborative mobility risk assessment platform; and an interactive system for driving optimization that may be deployed using push-button deployment via a graphical user interface (GUI) of the collaborative mobility risk assessment platform, wherein the collaborative mobility risk assessment platform may be sharable with multiple parties to participate in assessment and mitigation of risk for a plurality of types of autonomous and non-autonomous vehicles. The plurality of forms of data may include telematics data, driver history data, weather data, insurance data, vehicle history data, traffic data, road condition data, and other third-party data that may be used to predict risk of collision, breakdown, or accelerated depreciation of a vehicle. The one or more client applications may be selected from the group comprising: route optimization, input for upgraded driver risk index, insurance policy pricing, driver safety/monitoring, and asset management and residual value. The interactive system for driving optimization may include a fully interactive dashboard for live business analytics, prebuilt metric or visual views, and custom views. The one or more data lakes may be an automatic data lake that receives data through one or more APIs selected from the group comprising: device, transaction, vehicle, event, telemetry, trip, diagnostic, safety, and/or behavioral APIs. The plurality of forms of data may be normalized into a universal data format. The plurality of forms of data may be historical data and/or real-time data. The multiple parties may include a provider of the collaborative mobility risk assessment platform, insurance companies, fleet managers, automobile manufacturers (OEM), sellers of after-market automotive parts or services, vehicle dealerships, providers of alternative mobility solutions, and banking institutions.

### BRIEF DESCRIPTION OF THE DRAWINGS

For a more complete understanding of this disclosure, reference is now made to the following description, taken in conjunction with the accompanying drawings, in which:

FIG. 1 depicts a collaborative mobility risk assessment platform according to an embodiment of the present disclosure;

FIG. 2 depicts data ingestion for a collaborative mobility risk assessment platform according to an embodiment of the present disclosure; and

FIGS. 3A-3D depict interface configurations according to an embodiment of the present disclosure.

### DETAILED DESCRIPTION

Embodiments of the present disclosure may provide a collaborative mobility risk assessment platform that may enable multiple parties to participate in the assessment and mitigation of risk for a plurality of types of autonomous and non-autonomous vehicles. A platform according to embodiments of the present disclosure may provide assessment and mitigation of risk via machine learning and/or artificial intelligence. Multiple parties may include, but are not limited to, the provider of the collaborative mobility risk assessment platform and/or the provider's customers/users which may include, but are not limited to, insurance companies, fleet managers, automobile manufacturers (OEM), sellers of after-market automotive parts or services, vehicle dealerships, providers of alternative mobility solutions (i.e., scooters or bicycles), and/or banking institutions. It should be appreciated that autonomous and non-autonomous vehicles may include all forms of transportation including, but not limited to, cars, trucks (light and heavy), motorcycles, scooters, bicycles, and/or other alternative mobility solutions in embodiments of the present disclosure.

The platform according to embodiments of the present disclosure may include one or more interfaces to ingest a plurality of forms of data including, but not limited to, telematics data, driver history data, weather data, insurance data, vehicle history data, traffic data, road condition data as well as any relevant third-party data that may be used to predict the risk of collision, breakdown, or accelerated depreciation of autonomous and non-autonomous vehicles. The one or more interfaces may include an application platform interface (API) that may connect telematics data of the customer/user and/or other data associated with autonomous or non-autonomous vehicle to the collaborative mobility risk assessment platform. The one or more interfaces additionally or alternatively may include an API that may connect one or more third-party information systems with data that may be relevant to the data of the customer/user to the collaborative mobility risk assessment platform.

It should be appreciated that different interfaces may be used depending on the type of data being handled in embodiments of the present disclosure. For example, telematics data may be handled using a standard API that may be associated with the collaborative mobility risk assessment platform and/or an API may be created for each supplier of telematics data that may convert that data into a format that may be used by the standard API associated with the collaborative mobility risk assessment platform. Non-telematics data may be handled with a plurality of different APIs conforming to the type of data that may be ingested through the collaborative mobility risk assessment platform including, but not limited to, weather, roads, financial information associated with the vehicle, map data, emissions data, tire data, fuel price, maintenance data, and/or diagnostic trouble code information. After telematics and/or non-telematics data is ingested through an API associated with the collaborative mobility risk assessment platform, a vehicle information system, such as described, for example, in Applicant's commonly owned U.S. Pat. No. 9,990,781, which is incorporated by reference herein, may perform post-processing on the data and then redirect the data to a data intelligence platform.

As previously discussed, the platform according to embodiments of the present disclosure may be used to predict the risk of accident, maintenance, breakdown, and/or accelerated depreciation of autonomous and non-autonomous vehicles. It should be appreciated that the interfaces may be configured in different manners depending on how they are being used in connection with the collaborative mobility risk assessment platform.

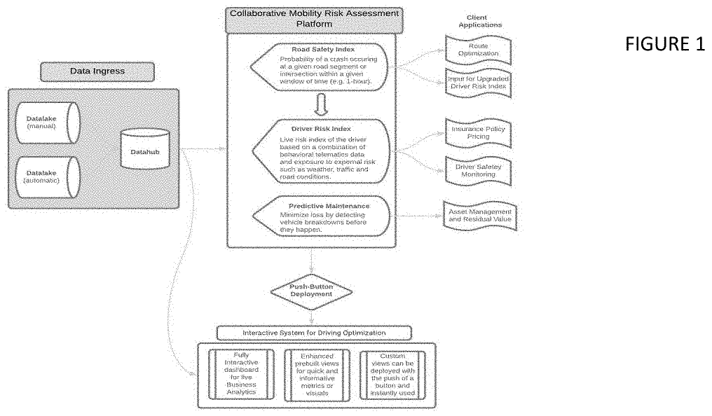

FIG. 1 depicts a collaborative mobility risk assessment platform according to an embodiment of the present disclosure. As depicted herein, two types of data lakes may feed into a data hub. It should be appreciated that data feeding into the APIs may be manual (i.e., where a user uploads data) and/or automatic (i.e., where data may be continually streamed into the platform from one or more external sources such as a telematics service provider or a weather service). The data hub may then feed data into the collaborative mobility risk assessment platform in an embodiment of the present disclosure.

The collaborative mobility risk assessment platform according to embodiments of the present disclosure may include a road safety index which is a probability of a crash or an accident occurring at a given road segment or intersection within a given window of time (e.g., 1 hour). The platform also may include a driver risk index which is a live risk index of a driver based on a combination of behavioral telematics data and exposure to external risk, such as weather, traffic, and/or road conditions. The platform may further include predictive maintenance which may minimize loss by detecting vehicle breakdowns before they happen. This also may include anomaly detection and diagnostic trouble code (DTC) analysis.

Various client applications may be provided through the collaborative mobility risk assessment platform according to embodiments of the present disclosure. These client applications may include, but are not limited to, route optimization (route monitoring/route planning), input for upgraded driver risk index, setup traffic rules/restrictions by local governments, such as only allowing small vehicles or EV cars to pass certain areas during a certain time, company office/warehouse site selection or airport/train or bus station/elementary school/community parks selection, capturing vehicle locations and provide vehicle density for a special event and parking availability, capturing speed limit/traffic lights/stop signs using traffic sign recognition technology, insurance policy pricing, drive safety monitoring (i.e., alert drivers via smartphone messaging and/or fleet managers being noticed in a fleet management system), driver evaluation by companies or teenager education school, personal driving reports for job searching or for fleet managers to use it to give bonuses for good drivers, vacation or rental car discounts, evaluate or train self-driving vehicles (i.e., provide a score for each self-driving segment), and/or asset assessment management and residual value. Asset management and residual value may include, but is not limited to, smart alerts and reminders, expense and maintenance logs, transformation of raw trouble code data into actionable information, service history dashboard, and/or battery status/KPI tracking for EV cars (i.e., charging time for different temperatures or assessing charging location quality). In an embodiment of the present disclosure, the driver risk index assessment contained within the platform may be pushed into a client application system for managing insurance records/profiles.

FIG. 1 also depicts push-button deployment wherein the platform provider, the customer/user, or both the platform provider and the customer/user may create data science models in a data intelligence platform. These models may be containerized and deployed within the data intelligence platform through the data intelligence platform's graphical user interface (“GUI”) which can then be accessed with any type of programming language by either the customer/user or the platform provider via API in embodiments of the present disclosure. Through this push-button deployment, an interactive system for driving optimization may be provided. For example, if a data science model as previously described is deployed and determines that an individual driver needs improvement with his/her driving, this information may be fed back into a data intelligence platform so that a recommendation may be made. It should be appreciated that this interactive system for driving optimization may include, but is not limited to, a fully interactive dashboard for live business analytics (such as through a mobile application and/or a computer interface), enhanced prebuilt views for quick and informative metrics or visuals, custom views that can be deployed through the data intelligence platform's GUI and instantly used, and/or vehicle residual value evaluation.

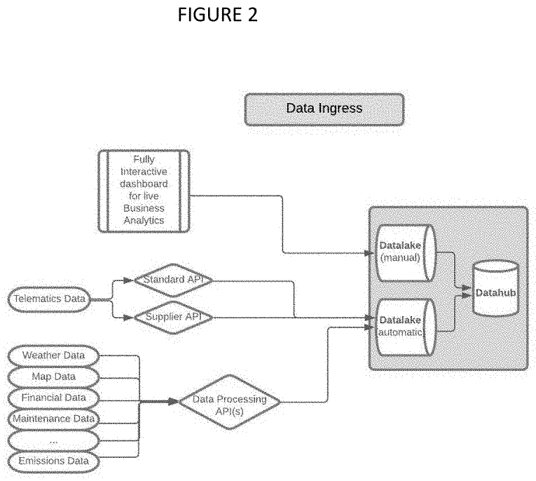

FIG. 2 depicts data ingestion for a collaborative mobility risk assessment platform according to an embodiment of the present disclosure. As discussed with respect to FIG. 1, an interactive system for driving optimization may provide a fully interactive dashboard for live business analytics, and data associated with that dashboard may be fed manually into a data lake in an embodiment of the present disclosure. Telematics data may be provided through a standard API and/or a supplier API in an automatic data lake in an embodiment of the present disclosure. Data including, but not limited to, weather data, map data, financial data, maintenance data, and/or emissions data may be provided through one or more data processing APIs into an automatic data lake in an embodiment of the present disclosure. Other APIs may include, but are not limited to, device, transaction, vehicle, event, telemetry, trip, diagnostic, safety, and/or behavioral APIs. These APIs can be used in connection with applications for use on the platform that request data or other information with an API and receive from the platform, third-party content providers or other data repositories.

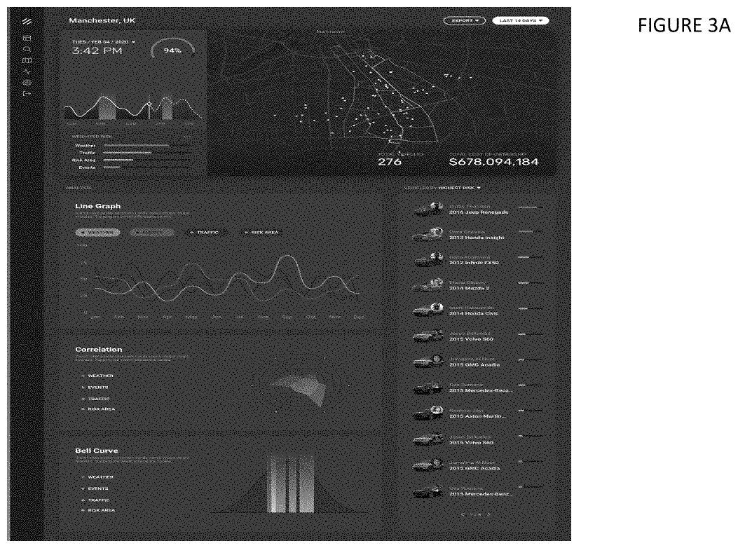

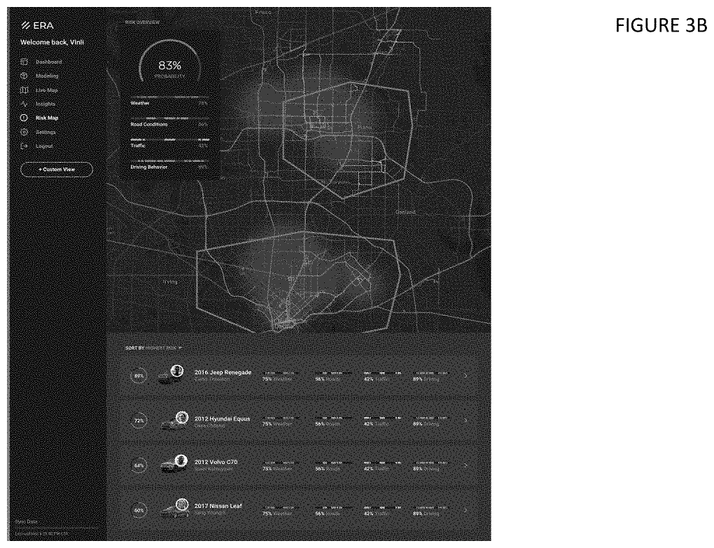

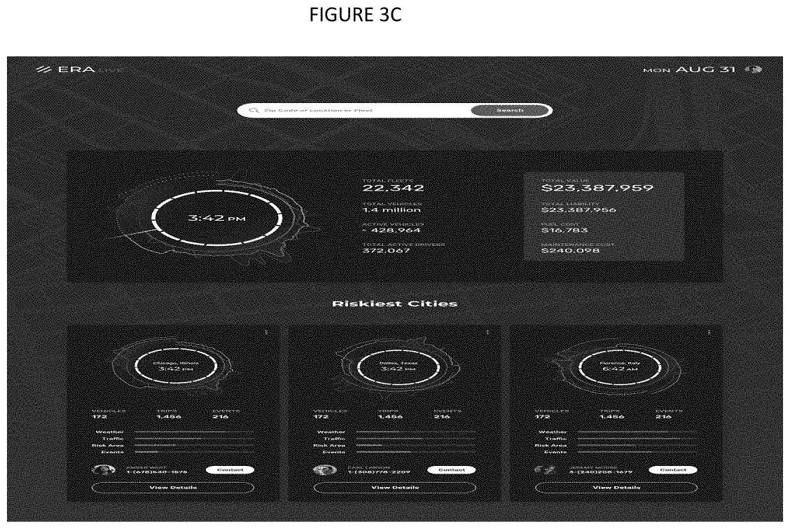

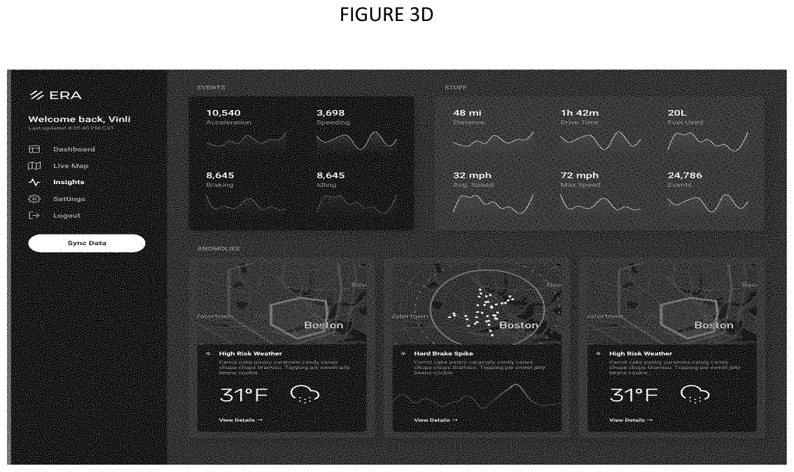

FIGS. 3A-3D depict different interface configurations according to an embodiment of the present disclosure. While interface configurations are depicted herein, it should be appreciated that more interface configurations may be associated with the platform than are depicted in FIGS. 3A-3D. It also should be appreciated that more or fewer items of information may be provided in an interface configuration without departing from the present disclosure.

FIG. 3A depicts an interface configuration associated with a specific city at a specific date/time according to an embodiment of the present disclosure. In this embodiment, the interface may provide a weighted risk of driving in the specific city based on factors including weather, traffic, risk area, and events. While certain factors are depicted herein, it should be appreciated that the weighted risk may be derived based on more or fewer factors without departing from the present disclosure. The weighted risk may be depicted using colors and/or numbers in embodiments of the present disclosure. For example, as depicted in FIG. 3A, colors from green (best) to red (worst) may be associated with each factor. Line graphs may be provided on the interface configuration with a line associated with each of the factors comprising the weighted risk so that a user may evaluate how the factors may change depending on the month of the year or other delineations of time in embodiments of the present disclosure. The interface configuration also may provide a pictorial correlation of the factors comprising the weighted risk in embodiments of the present disclosure. A bell curve of the factors comprising the weighted risk also may be included. While different graphical/pictorial depictions of the factors that may comprise the weighted risk are depicted in FIG. 3A, it should be appreciated that more or fewer depictions may be provided without departing from the present disclosure.

The upper left corner of the interface of FIG. 3A may provide a percentage risk at a specified date/time for the specific city (i.e., 94% for Tuesday, Feb. 4, 2020 at 3:42 PM). A graphical depiction also may be provided that may show how the percentage risk may change depending on the time of day. FIG. 3A also depicts a map indicating the location of each vehicle being analyzed in connection with the specific city. In connection with this map, the number of vehicles being analyzed may be identified and/or the total cost of ownership of the vehicles being analyzed. This interface configuration also may include a listing of the vehicles ranked based on the highest to lowest risk in an embodiment of the present disclosure. This vehicle listing may include information about each vehicle, including but not limited to, type of vehicle, user/owner of the vehicle, the vehicle year, and a color and/or numerical depiction of the risk.

FIG. 3B depicts an interface configuration providing a risk overview in an embodiment of the present disclosure. In this embodiment, a percentage probability of risk is provided along with percentages for various factors including weather, road conditions, traffic, and driving behavior. As discussed with respect to FIG. 3A, more or fewer factors may be provided without departing from the present disclosure. This interface configuration also may include one or more maps that may identify areas where the risk associated with factors may be higher. These areas may be identified through colors associated with the different factors in embodiments of the present disclosure.

As with FIG. 3A, FIG. 3B includes a listing of the vehicles ranked based on the highest to lowest risk in an embodiment of the present disclosure. However, the listing in FIG. 3B provides additional information with respect to each vehicle. More specifically, each vehicle may have an overall risk percentage probability as well as risk percentage probabilities in connection with each of the factors. For example, the first vehicle depicted in FIG. 3B (2016 Jeep Renegade) has an overall 89% risk percentage probability. The individual factor risk probabilities are: 75% weather, 56% roads, 42% traffic, and 89% driving. The second vehicle (2012 Hyundai Equus) has the same percentage probabilities associated with the factors as the first vehicle. However, the second vehicle has been determined to be less of a risk under the same conditions than the first vehicle.

FIG. 3C depicts an interface configuration that may provide a live look at risk overall (i.e., across all vehicles being managed through the platform) and/or within a zip code, in a location, and/or by fleet in embodiments of the present disclosure. As depicted herein, at a specified date and time, the interface may provide information about the total fleets, the total number of vehicles within the fleets, active vehicles, active drivers, total value of the vehicles, total liability, fuel cost, and/or maintenance cost. While each of these items are depicted herein for the overall risk being managed through the platform, it should be appreciated that more or fewer items may be included without departing from the present disclosure.

FIG. 3C also includes summary data for the riskiest cities at a given date and time. For each city, the city may be identified along with the number of vehicles, trips, and/or events. Factors being monitored related to risk, including but not limited to, weather, traffic, risk area, and/or events may be depicted including a color and/or numerical representation of the risk probability associated with each factor. The platform also may include a contact person that may be associated with each city and means to contact that person in embodiments of the present disclosure. More details may be viewed for each city by selecting “view details” or other similar input mechanism in embodiments of the present disclosure.

FIG. 3D depicts another interface configuration according to an embodiment of the present disclosure. In this embodiment, a user may view specific information about events including, but not limited to, acceleration, speeding, braking, and/or idling. A user also may view items including, but not limited to, distance, drive time, fuel used, average speed, maximum speed, and/or events in embodiments of the present disclosure. The events and/or items may be represented using numerical and/or graphical depictions in embodiments of the present disclosure. Anomalies also may be depicted in this interface configuration. Anomalies may include, but are not limited to, high risk weather and/or hard brake spikes, and anomalies may be depicted with numerical and/or textual data and/or map depictions in embodiments of the present disclosure. For example, a high-risk weather anomaly may be identified in Boston because the temperature is below freezing and there is precipitation. More details about the weather conditions may be provided by selecting “view details” or other similar input mechanism in embodiments of the present disclosure.

The platform according to embodiments of the present disclosure may be shared with multiple parties for purposes of collaboration to make risk mitigation determinations so as to minimize or eliminate sub-standard performance and/or non-performance with respect to areas including, but not limited to, routes, insurance policies, maintenance, fuel management, and/or asset pricing using cloud-based services which may include, but are not limited to, maintenance services, diagnostic services which may provide access to diagnostic information such as DTC codes and/or historical diagnostics, communication services, trip services which may automatically detect trips for a vehicle and provide telemetry and other information on a trip-by-trip basis, behavioral services (i.e., which may provide “report cards” for vehicles based on a driver's behavior), safety services (i.e., providing access to collision history and other collected safety information), location-based services, data collection services, and/or infrastructure services. When referring to cloud-based services, it should be appreciated that cloud-based services may be provided through a cloud computing site, cloud environment, or cloud platform running multiple servers, computers, or virtual machines (e.g., a virtual machine host computer). The platform may be hosted in a cloud-based environment so that it may be shared and used by customers/users of the platform. The optimizations described herein may be accessed as cloud-based services with various in graphical user interfaces (GUIs) and/or data inputs in embodiments of the present disclosure.

The collaborative mobility risk assessment platform according to embodiments of the present disclosure may be powered by both machine learning and big data analytics to find correlation between any data set provided by any source and in any format. As a self-learning engine, the platform according to embodiments of the present disclosure requires minimal human input and guidance, intuitively generating innovative models and discovering hidden patterns without human bias or intervention. Data may be normalized, analyzed, correlated, and models generated from the data in embodiments of the present disclosure. It should be appreciated that these models may be generated in less time and at a lower cost than the models previously generated over months/years by a large team of costly data scientists. Existing models can be calibrated over time and new models may be discovered as correlations are validated or new data is added. By normalizing and processing the data, the platform according to embodiments of the present disclosure may answer questions but also identify questions that users may not realize should be asked, thereby providing business solutions through custom business services, custom applications, intelligent mobility ecosystem, and monetization. The platform according to embodiments of the present disclosure may build on the intelligence that it gains from a known dataset, opening the door for new datasets to be uncovered as derivatives of the initial dataset. The models produced and maintained may be wrapped in intelligence service APIs that can be consumed in mobility applications, services, and/or solutions in embodiments of the present disclosure.

It should be appreciated that the platform according to embodiments of the present disclosure may consume data of all types in all formats including, but not limited to, video, audio, images, text, and/or time series. The datasets may be normalized into a universal data format. The platform according to embodiments of the present disclosure may be seeded with historical data but also take in new data in real time as it is generated.

In various embodiments, modules or software can be used to practice certain aspects described herein. For example, software-as-a-service (SaaS) models or application service provider (ASP) models may be employed as software application delivery models to communicate software applications to clients or other users. Such software applications can be downloaded through an Internet connection, for example, and operated either independently (e.g., downloaded to a laptop or desktop computer system) or through a third-party service provider (e.g., accessed through a third-party web site). In addition, cloud computing techniques may be employed in connection with various embodiments of the invention.

Various embodiments of the systems and methods may include and/or utilize one or more computing devices. In various embodiments, a computer may be in communication with a server or server system utilizing any suitable type of communication including, for example, wired or wireless digital communications. In some embodiments, the server or server system may be implemented as a cloud computing application or in a similar manner and may provide various functionality of the systems and methods as SaaS.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for collaborative mobility risk assessment comprising:
receiving a datahub having one or more data lakes into a cloud-based collaborative mobility risk assessment platform, the collaborative mobility risk assessment platform including a road safety index, a driver risk index, and predictive maintenance;
feeding the road safety index, the driver risk index, and predictive maintenance to one or more client applications; and
using push-button deployment via a graphical user interface (GUI) of the collaborative mobility risk assessment platform, providing an interactive system for driving optimization, wherein the collaborative mobility risk assessment platform is sharable with multiple parties to participate in assessment and mitigation of risk for a plurality of types of autonomous and non-autonomous vehicles.

2. The method of claim 1, the interactive system for driving optimization comprising:
a fully interactive dashboard for live business analytics, prebuilt metric or visual views, and custom views.

3. The method of claim 1 where the one or more data lakes are manual and/or automatic.

4. The method of claim 3 wherein the manual data lake is populated through a fully interactive dashboard for live business analytics in the interactive system for driving optimization.

5. The method of claim 3 wherein the automatic data lakes are populated from one or more external sources.

6. The method of claim 5, wherein the one or more external sources is a telematics service provider that provides telematics data through a standard application programming interface (API) and/or a supplier API.

7. The method of claim 1, wherein the one or more data lakes is an automatic data lake that receives data through one or more data processing APIs.

8. The method of claim 7, wherein the data is selected from the group comprising:
weather data, map data, financial data, maintenance data, and emission data.

9. The method of claim 1, wherein the one or more data lakes is an automatic data lake that receives data through one or more APIs selected from the group comprising:
device, transaction, vehicle, event, telemetry, trip, diagnostic, safety, and/or behavioral APIs.

10. The method of claim 1, the multiple parties comprising:
a provider of the collaborative mobility risk assessment platform, insurance companies, fleet managers, automobile manufacturers (OEM), sellers of after-market automotive parts or services, vehicle dealerships, providers of alternative mobility solutions, and banking institutions.

11. The method of claim 1, the plurality of types of autonomous and non-autonomous vehicles comprising:
cars, light and heavy trucks, motorcycles, scooters, bicycles, and alternative mobility solutions.

12. The method of claim 1, the one or more client applications selected from the group comprising:
route optimization, input for upgraded driver risk index, insurance policy pricing, driver safety/monitoring, and asset management and residual value.

13. A collaborative mobility risk assessment platform comprising:
one or more interfaces to ingest a plurality of forms of data and populate one or more data lakes that feed into a datahub;
a cloud-based collaborative mobility risk assessment platform that receives the datahub, the collaborative mobility risk assessment platform including a road safety index, a driver risk index, and predictive maintenance;
one or more client applications that receive the road safety index, the driver risk index, and/or predictive maintenance from the collaborative mobility risk assessment platform; and
an interactive system for driving optimization that is deployed using push-button deployment via a graphical user interface (GUI) of the collaborative mobility risk assessment platform, wherein the collaborative mobility risk assessment platform is sharable with multiple parties to participate in assessment and mitigation of risk for a plurality of types of autonomous and non-autonomous vehicles.

14. The platform of claim 13, the plurality of forms of data comprising:
telematics data, driver history data, weather data, insurance data, vehicle history data, traffic data, road condition data, and other third-party data that is used to predict risk of collision, breakdown, or accelerated depreciation of a vehicle.

15. The platform of claim 13, the one or more client applications selected from the group comprising:
route optimization, input for upgraded driver risk index, insurance policy pricing, driver safety/monitoring, and asset management and residual value.

16. The platform of claim 13, the interactive system for driving optimization comprising:
a fully interactive dashboard for live business analytics, prebuilt metric or visual views, and custom views.

17. The platform of claim 13, wherein the one or more data lakes is an automatic data lake that receives data through one or more APIs selected from the group comprising:
device, transaction, vehicle, event, telemetry, trip, diagnostic, safety, and/or behavioral APIs.

18. The platform of claim 13, wherein the plurality of forms of data are normalized into a universal data format.

19. The platform of claim 13, wherein the plurality of forms of data are historical data and/or real-time data.

20. The platform of claim 13, the multiple parties comprising:
a provider of the collaborative mobility risk assessment platform, insurance companies, fleet managers, automobile manufacturers (OEM), sellers of after-market automotive parts or services, vehicle dealerships, providers of alternative mobility solutions, and banking institutions.
